(19) United States
(12) Patent Application Publication
(10) Pub. No.: US 2009/0279824 A1
(43) Pub. Date: Nov. 12, 2009

(54) GREASE-ENCLOSED BEARING FOR INVERTER-DRIVING MOTOR

(75) Inventor: Hidenobu Mikami, Mie (JP)

Correspondence Address: HEDMAN & COSTIGAN P.C., 1185 AVENUE OF THE AMERICAS, NEW YORK, NY, 10036, US

(73) Assignee: NTN CORPORATION, Osaki (JP)

(21) Appl. No.: 12/312,136

(22) PCT Filed: Nov. 6, 2007
(86) PCT No.: PCT/JP2007/071512

§ 371 Date: Apr. 27, 2009

(30) Foreign Application Priority Data
Nov. 9, 2006 (JP) 2006-304398
Nov. 9, 2006 (JP) 2006-304419
May 18, 2007 (JP) 2007-133504

(51) Int. Cl. F16C 19/00

(52) U.S. Cl. 384/462

(57) ABSTRACT

The present invention provides a grease-enclosed bearing, for an inverter-driving motor, which is inexpensive and capable of effectively restraining damage from being generated by electrolytic corrosion. The grease-enclosed bearing for the inverter-driving motor has an inner ring (2), an outer ring (3), a plurality of rolling elements (4) disposed between the inner ring (2) and the outer ring (3), and a sealing member (6) covering both axial ends of the inner ring (2) and the outer ring (3). A grease (7) is enclosed on peripheries of the rolling elements (4). The grease (7) contains a base grease consisting of a base oil and a thickener and an additive, containing at least an electrolytic corrosion retarder, which is added to the base grease. The grease (7) is enclosed on peripheries of rolling surfaces of the bearing. The mixing ratio of the electrolytic corrosion retarder for 100 parts by weight of the base grease is set to 0.05 to 10 parts by weight.

### TECHNICAL FIELD

The present invention relates to a grease-enclosed bearing for an inverter-driving motor and more particularly to a grease-enclosed bearing for use in an inverter-driving motor for use in industrial machines and electric/electronic auxiliary machines of a car.

### BACKGROUND ART

Motors of electric/electronic parts of cars, auxiliary machines, and industrial machines are demanded to be compact and have high performances and high outputs year by year. Thus use conditions have become strict. A grease-enclosed deep groove ball bearing is normally used for the motors and is frequently used for motors driven by inverter control. Owing to convenience (simplicity of maintenance and checking, high speed, compliance with variableness) which can be obtained by the inverter control, there is a tendency for the ratio of the inverter control to increase. It is supposed that the tendency will continue. The inverter control adjusts a voltage and a frequency. In a rolling bearing incorporated in the motors driven by the inverter control, there is a possibility that the rolling surface of the rolling bearing is subjected to damage called “electrolytic corrosion” generated by the flow of high-frequency electric current thereinto from an inverter circuit.

To prevent the generation of the above-described disadvantage, techniques of making rolling elements constituting a bearing of ceramic to insulate them were proposed to avoid the electrolytic corrosion-caused damage (see patent documents 1, 2)

But the bearing made of ceramic is so expensive that the above-described measure cannot be widely used.

Patent document 1: Registered Patent No. 2991834

Patent document 2: Registered Patent No. 2934697

### DISCLOSURE OF THE INVENTION

### Problems to be Solved by the Invention

The present invention has been made to cope with the above-described problem. It is an object of the present invention to provide a grease-enclosed bearing, for an inverter-driving motor, which is inexpensive and capable of effectively restraining electrolytic corrosion-caused damage.

### Means for Solving the Problems

A grease-enclosed bearing of the present invention, for an inverter-driving motor, is used as a bearing supporting a rotor of the inverter-driving motor driven by inverter control. The grease-enclosed bearing has an inner ring, an outer ring, a plurality of rolling elements disposed between the inner ring and the outer ring, and a sealing member provided at openings disposed at both axial ends of the inner ring and the outer ring. The inner ring, the outer ring, and the rolling elements are made of an iron-based alloy respectively. The grease enclosed on peripheries of the rolling elements contains a base grease consisting of a base oil and a thickener and an additive containing at least an electrolytic corrosion retarder that restrains the generation of electrolytic corrosion. The electrolytic corrosion retarder is an organic-acid metal salt, a phosphoric acid compound or an epoxy compound. The mixing ratio of the electrolytic corrosion retarder for 100 parts by weight of the base grease is set to 0.05 to 10 parts by weight.

The organic-acid metal salt is at least one fatty acid metal salt selected from among fatty acid aluminum, fatty acid zinc, fatty acid calcium, and fatty acid magnesium.

The fatty acids are aliphatic organic acids having not less than eight carbon atoms.

The phosphoric acid compound is at least one phosphoric acid ester selected from among tricresyl phosphate, trioctyl phosphate, and triphenyl phosphate.

The epoxy compound is at least one epoxy compound selected from among a bisphenol A type and a bisphenol F type.

The thickener is au urea-based thickener or a lithium soap-based thickener.

The base oil is at least one oil selected from among ester oil and poly-α-olefin oil.

### EFFECT OF THE INVENTION

Because the grease enclosed in the bearing for the inverter-driving motor contains the base grease consisting of the base oil and the thickener and the electrolytic corrosion retarder consisting of the organic-acid metal salt, the phosphoric acid compound or the epoxy compound, the rolling surface or the like are restrained from being damaged (electrolytic corrosion) by high-frequency electric current which has flowed thereinto from the inverter circuit and the bearing can be used for a long time. Further because it is possible to use the iron-based alloy for the inner ring, the outer ring, and the rolling elements, it is unnecessary to use ceramics or the like for the bearing. Therefore the bearing can be obtained at a low cost.

### BRIEF DESCRIPTION OF THE DRAWINGS

FIG. 1(a) is a schematic sectional view of a motor using a bearing for a motor as a bearing for an output motor.

FIG. 1(b) is an enlarged view of a portion A of FIG. 1(a).

FIG. 2 is a sectional view of a deep groove ball bearing.

### EXPLANATION OF REFERENCE NUMERALS AND SYMBOLS

1: grease-enclosed bearing for inverter-driving motor
2: inner ring
3: outer ring
4: rolling element
5: retainer
6: sealing member
7: grease
8a: opening
8b: opening
10: motor
11: motor main shaft
12: stator
13: rotor
14: flange
15: first radial ball bearing
16: second radial ball bearing
17: pulley
18: belt
19: wave spring washer

### BEST MODE FOR CARRYING OUT THE INVENTION

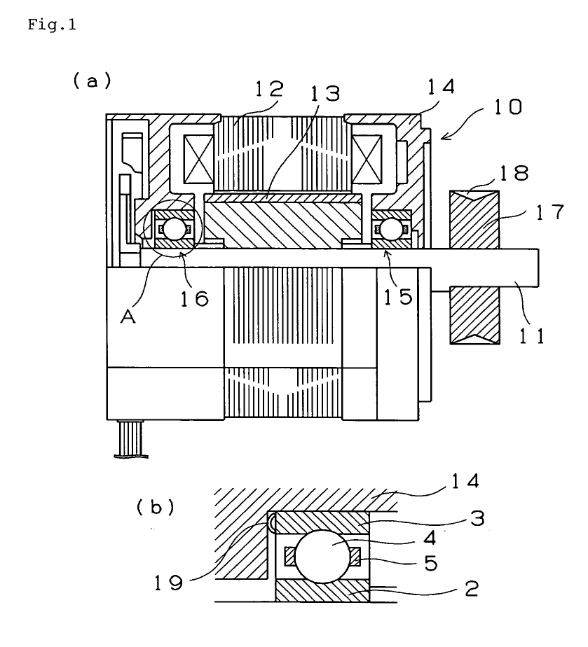

One embodiment of the present invention is described below with reference to the drawings. FIG. 1 shows an example of a grease-enclosed bearing for an inverter-driving motor supporting a rotor of a motor. FIG. 1(a) is a schematic sectional view of a motor using a bearing for a motor as a bearing for an output motor. FIG. 1(b) is an enlarged view of a portion A of FIG. 1(a).

As shown in FIGS. 1(a), 1(b), in a motor 10, a belt 18 is mounted on a pulley 17 interlocked with a main shaft 11, thus a load is rotated. In the motor 10, a rotor 13 is mounted on the main shaft 11, and the pulley 17 and the belt 18 for rotating an air-conditioning fan are mounted on the main shaft 11 at one end thereof. The main shaft 11 is rotatably supported on a flange 14 by a first radial ball bearing 15 mounted on one end of the rotor 13 and a second radial ball bearing 16 (bearing for motor) mounted on the other end of the rotor 13. A stator 12 is fixed to the flange 14 with the stator 12 opposed to the rotor 13. A wave spring washer 19 is disposed between the flange 14 and the second radial ball bearing 16, thus imparting a preload thereto.

FIG. 1(b) shows a state in which a preloading method to be carried out by using a spring is adopted. A coned disk spring and the wave spring washer 19 are disposed between the flange 14 and the second radial ball bearing 16 to impart the preload thereto. As shown in FIG. 1(b), each of the first radial ball bearing 15 and the second radial ball bearing 16 is constructed of an inner ring 2 serving as an inner member, an outer ring 3 serving as an outer member, a plurality of balls 4 serving as rolling elements, and a retainer 5 holding a plurality of the balls 4. As described above, the wave spring washer 19 is disposed between the flange 14 and the second radial ball bearing 16 to impart the preload thereto. A radial load is applied to the main shaft 11 by the belt 18. A generated strain is also applied to the inner ring 2 of the bearing. As a result, the angle at which the ball 4 shares the load inclines to a vertical contact surface.

In this embodiment, as the first radial ball bearing 15 and the second radial ball bearing 16, a deep groove ball bearing is used. In addition to the deep groove ball bearing, an angular ball bearing and a cylindrical roller bearing can be used.

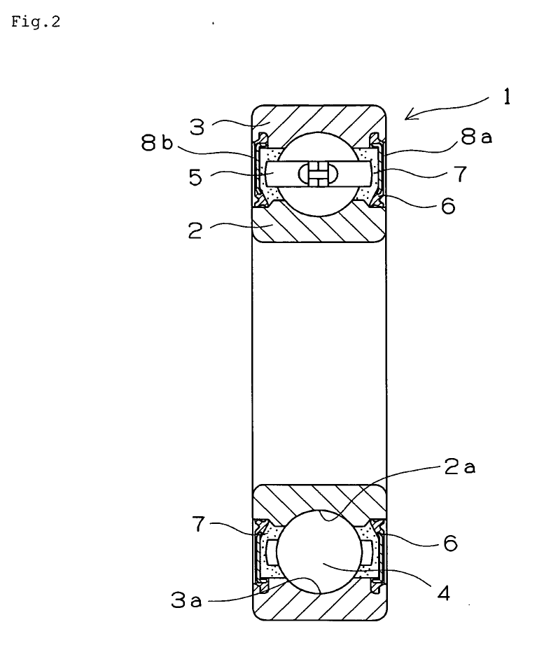

FIG. 2 is a sectional view of the deep groove ball bearing. In a deep groove ball bearing 1, an inner ring 2 having an inner ring rolling surface 2a on its peripheral surface and an outer ring 3 having an outer ring rolling surface 3a on its inner peripheral surface are concentrically disposed, and a plurality of rolling elements 4 is disposed between the inner ring rolling surface 2a and the outer ring rolling surface 3a. A retainer 5 holding the rolling elements 4 is provided. A sealing member 6 fixed to the outer ring 3 and other is provided at openings 8a and 8b disposed at both axial ends of the inner ring 2 and the outer ring 3 with the sealing member 6 covering the openings 8a and 8b. A grease 7 containing an electrolytic corrosion retarder which is described later is enclosed at least on the peripheries of rolling elements 4. An iron-based alloy can be used for the inner ring, the outer ring, and the rolling element of the bearing.

In the present invention, the electrolytic corrosion retarder is capable of preventing the generation of electrolytic corrosion at the time of energization owing to a film of the above-described substance formed on rolling surfaces of the bearing. The film is capable of decreasing the extent of the wear of the rolling surfaces of the bearing. The electrolytic corrosion retarder that can be used in the present invention is selected from among organic-acid metal salts, phosphoric acid compounds, and epoxy compounds.

As the organic-acid metal salt that can be used in the present invention, it is possible to use metal salts of any of aromatic organic acids, aliphatic organic acids, and alicyclic organic acid. These organic-acid metal salts may be added to the grease singly or in combination of two or more kinds thereof.

As metals for use in the organic-acid metal salt, it is preferable to use aluminum, zinc, calcium, magnesium and the like. As the organic acid, it is possible to use monobasic and polybasic organic acids.

Listed as the organic acids are monovalent saturated fatty acids such as formic acid, acetic acid, propionic acid, butyric acid, valeric acid, caproic acid, heptanoic acid, caprylic acid, pelargonic acid, capric acid, undecylic acid, lauric acid, tridecylic acid, myristic acid, pentadecylic acid, palmitic acid, margaric acid, stearic acid, nonadecylic acid, and arachic acid; monovalent unsaturated fatty acids such as acrylic acid, crotonic acid, undecylenic acid, oleic acid, gadoleic acid; bivalent saturated fatty acids such as malonic acid, methylmalonic acid, succinic acid, methylsuccinic acid, dimethylmalonic acid, ethylmalonic acid, glutaric acid, adipic acid, dimethylsuccinic acid, pimelic acid, tetramethylsuccinic acid, suberic acid, azelaic acid, sebacic acid, brassylic acid; bivalent unsaturated fatty acids such as fumaric acid, maleic acid; derivatives of fatty acid such as tartaric acid, citric acid; aromatic organic acids such as benzoic acid, phthalic acid, trimellitic acid, and pyromellitic acid.

Of these organic acids, it is favorable to use the aliphatic organic acid (fatty acid) such as the lauric acid, the margaric acid, the stearic acid, and the nonadecylic acid having not less than 8 carbon atoms. It is especially favorable to use the stearic acid.

The organic-acid metal salt preferable in the present invention includes aluminum stearate, zinc stearate, and calcium stearate. Of these organic-acid metal salts, the aluminum stearate is especially favorable.

By adding the above-described organic-acid metal salts as an additive to the grease which is used in the present invention, a film of the organic-acid metal salt is formed on the rolling surfaces of the bearing. The film of the organic-acid metal salt formed on the rolling surfaces of the bearing has an effect of decreasing the extent of the wear thereof at the time of energization and is capable of preventing the generation of the electrolytic corrosion.

The mixing ratio of the organic-acid metal salt for 100 parts by weight of the base grease which is described later is favorably 0.05 to 10 parts by weight and more favorably 0.1 to 5 parts by weight. When the mixing ratio of the organic-acid metal salt is less than 0.05 parts by weight, the extent of the electrolytic corrosion-caused wear of the rolling surface or the like cannot be sufficiently decreased. On the other hand, when the mixing ratio of the organic acid metal salt is more than 10 parts by weight, an abnormal wear occurs.

As the phosphoric acid compound that can be used in the present invention, phosphoric acid ester and phosphoric acid metal salt are listed. As examples of the phosphoric acid ester, tricresyl phosphate (TCP), trioctylphosphate (TOP), triphenylphosphate (TPP), tributyl phosphate (TBP), phosphorous acid ester, and acid phosphoric acid ester are listed. As examples of the metal salt of the phosphoric acid, lithium phosphate and calcium phosphate are listed. These phosphoric acid compounds may be added to the grease singly or in combination of two or more kinds thereof.

Of these phosphoric acid compounds, phosphoric acid ester is favorable because the phosphoric acid ester can be adsorbed to the surface of a metal and easily forms a film capable of decreasing the extent of the electrolytic corrosion-caused wear. The tricresyl phosphate, the trioctyl phosphate, and the triphenyl phosphate are especially favorable because these phosphoric acid esters are excellent in the heat stability thereof.

In the grease to be used in the present invention, by adding the above-described phosphoric acid compounds to the grease as an additive, the film of iron phosphate or iron phosphide is formed on the rolling surfaces of the bearing. The film formed on the rolling surfaces of the bearing has an effect of decreasing the extent of the wear thereof at the time of energization and is capable of preventing the generation of the electrolytic corrosion.

The mixing ratio of the phosphoric acid compound for 100 parts by weight of the base grease which is described later is favorably 0.05 to 10 parts by weight and more favorably 0.1 to 5 parts by weight. When the mixing ratio of the phosphoric acid compound is less than 0.05 parts by weight, the extent of the electrolytic corrosion-caused wear of the rolling surface or the like cannot be sufficiently decreased. On the other hand, when the mixing ratio of the phosphoric acid compound is more than 10 parts by weight, an abnormal wear occurs.

As the epoxy compound that can be used in the present invention, it is possible to exemplify epoxy compounds known as epoxy resin components generally used in liquid epoxy resin compositions for sealing. The solid epoxy compound or the liquid may be used or both may be used. It is possible to exemplify glycidyl ether-type epoxy resin obtained by reaction between epichlorohydrin and bisphenol A, bisphenol F or bisphenol AD or the like; novolak-type epoxy resin consisting of epoxidized novolak resin obtained by condensation or co-condensation between phenols such as orthocresol novolak-type epoxy resin and aldehydes; glycidyl ester-type epoxy resin obtained by reaction between the epichlorohydrin and polybasic acid such as phthalic acid, dimer acid, and the like; glycidyl amine-type epoxy resin obtained by reaction between the epichlorohydrin and polyamine such as diaminodiphenylmethane, isocyanuric acid or the like; linear aliphatic epoxy resin and alicyclic epoxy resin obtained by oxidizing olefin bond with peracid such as peracetic acid. These epoxy compounds may be used singly or in combination of not less than two kinds thereof. Of the above-described epoxy compounds, those shown by the following chemical formulas are favorable. The epoxy compounds of the bisphenol A-type shown by the following chemical formula 1, the bisphenol F-type shown by the following chemical formula 2, and the glycidyl ether-type epoxy resin are more favorable because these epoxy compounds dissolve in the grease to a high extent.

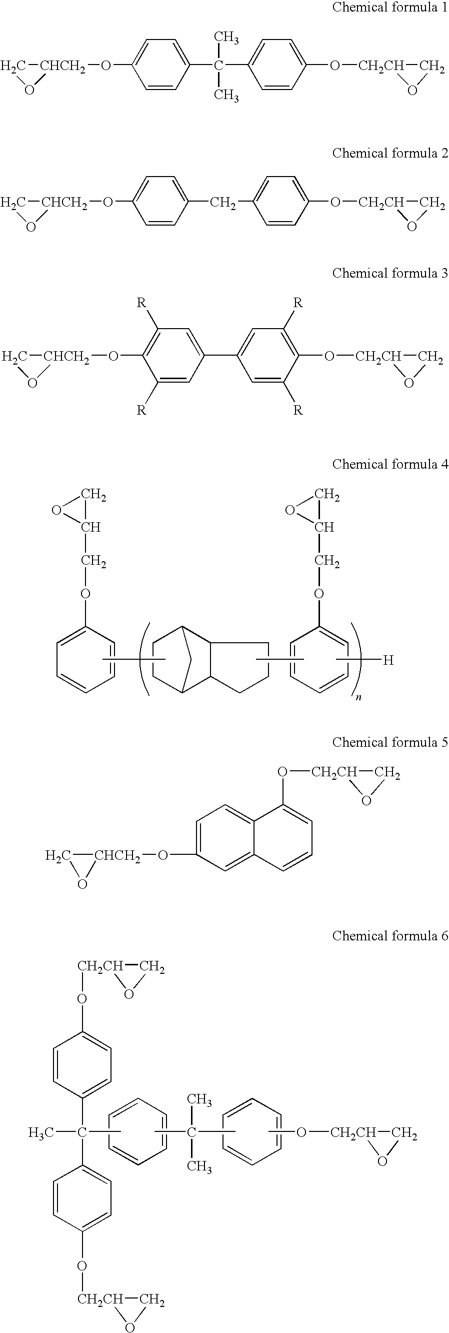

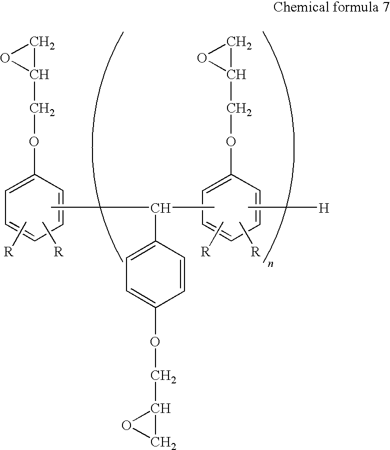

In the equation, R denotes a hydrogen atom or an alkyl group such as a methyl group. Reference numeral n denotes integers not less than 1 and favorably 1 to 10, and more favorably 1 to 5.

By using the above-described epoxy compounds for the grease to be used in the present invention as an additive, a film of the epoxy compound is formed on the rolling surfaces of the bearing. The film of the epoxy compound formed on the rolling surfaces of the bearing has an effect of decreasing the extent of the wear thereof at the time of energization and is capable of preventing the generation of the electrolytic corrosion.

The mixing ratio of the epoxy compound for 100 parts by weight of the base grease which is described later is favorably 0.05 to 10 parts by weight and more favorably 0.1 to 5 parts by weight. When the mixing ratio of the epoxy compound is less than 0.05 parts by weight, electrolytic corrosion-caused wear of the rolling surface or the like cannot be sufficiently decreased. On the other hand, when the mixing ratio of the epoxy compound is more than 10 parts by weight, an abnormal wear occurs.

As the base oil that can be used for the grease of the present invention, it is possible to use mineral oil such as spindle oil, oil for a refrigerator, turbine oil, machine oil, dynamo oil; hydrocarbon synthetic oil such as highly refined mineral oil, liquid paraffin, polybutene oil, GTL base oil synthesized by Fischer-Tropsch method, poly-α-olefin oil, alkylnaphthalene, alicyclic compounds; non-hydrocarbon synthetic oil such as natural fats and oils, polyol ester oil, phosphoric acid ester oil, polymer ester oil, aromatic ester oil, carbonate ester oil, diester oil, polyglycol oil, silicone oil, polyphenyl ether oil, alkyldiphenyl ether oil, alkylbenzene oil, and fluorinated oil. These base oils may be used singly or in combination of not less than two kinds thereof.

Of these base oils, the ester oil and the poly-α-olefin oil are preferable because these oils are excellent in terms of heat resistance, lubricating performance, and a low-extent noise generation.

As the thickener that can be used in the present invention, it is possible to use Benton; silica gel; fluorine compounds; soaps such as lithium soap, lithium complex soap, calcium soap, calcium complex soap, aluminum soap, aluminum complex soap; and an urea compound such as a diurea compound and a polyurea compound.

In consideration of low-extent noise generation, heat resistance, and cost, the urea compound and the lithium soap compound are favorable. The urea compound is more favorable.

The urea compound is obtained by a reaction between an isocyanate compound and an amine compound. To prevent a reactive free radical from remaining, it is preferable to add the isocyanate compound and the amine compound to the base oil so that the isocyanate group of the isocyanate compound and the amino group of the amine compound are approximately of the same equivalent weight.

The diurea compound can be obtained by a reaction between diisocyanate and monoamine. Listed as the diisocyanate are phenylene diisocyanate, tolylene diisocyanate, diphenyl diisocyanate, diphenylmethane diisocyanate, octadecane diisocyanate, decane diisocyanate, and hexane diisocyanate. Octylamine, dodecylamine, hexadecylamine, stearylamine, oleylamine, aniline, p-toluidine, and cyclohexylamine are listed as the monoamine. The polyurea compound can be obtained by a reaction between the diisocyanate and the monoamine and diamine. As the diisocyanate and the monoamine, substances similar to those used to form the diurea compound are listed. As the diamine, ethylenediamine, propanediamine, butanediamine, hexanediamine, octanediamine, phenylenediamine, tolylenediamine, xylenediamine, and diaminodiphenylmethane are listed.

By adding the thickener such as the urea compound to the base oil, the base grease to which the electrolytic corrosion retarder is added is obtained. The base grease containing the urea compound as its thickener is produced by allowing the isocyanate compound and the amine compound to react with each other in the base oil.

The mixing ratio of the thickener to be contained in 100 parts by weight of the base grease is favorably 1 to 40 parts by weight and more favorably 3 to 25 parts by weight. When the content of the thickener is less than 1 part by weight, thickening effect is obtained to a low extent and greasing is difficult. On the other hand, when the content of the thickener is more than 40 parts by weight, the obtained base grease is so hard that it is difficult to obtain a desired effect.

In the present invention, a known additive for the grease can be added to the base grease together with the electrolytic corrosion retarder as necessary. As the additive, it is possible to use an antioxidant such as compounds containing organic zinc compounds, amine compounds or phenol compounds; a metal deactivator such as benzotriazole; a viscosity index improver such as polymethacrylate and polystyrene; a solid lubricant such as molybdenum disulfide and graphite; a rust inhibitor such as metal sulfonate and polyvalent alcohol ester; a friction-reducing agent such as organic molybdenum; an oiliness agent such as ester and alcohol; and a wear-preventing agent. These additives can be added to the base grease singly or in combination of not less than two kinds thereof.

Because the grease used in the present invention is capable of restraining the extent of the electrolytic corrosion-caused wear, it is possible to prolong the life of the grease-enclosed bearing for the inverter-driving motor. Thus the grease of the present invention can be used for a ball bearing, a cylindrical roller bearing, a tapered roller bearing, a self-aligning roller bearing, a needle roller bearing, a thrust cylindrical roller bearing, a thrust tapered roller bearing, a needle roller thrust bearing, and a self-aligning thrust roller bearing.

### EXAMPLES

### Examples 1-1 through 1-6 and Comparison Examples 1-1 through 1-3

4,4′-diphenylmethane diisocyanate (Millionate MT produced by Nippon Polyurethane Industry Co., Ltd., hereinafter referred to as MDI) was dissolved in one half of a base oil shown in table 1 at a ratio shown in table 1. Monoamine was dissolved in the remaining half of the base oil at an equivalent weight two times larger than that of the MDI. The mixing ratio and the kind of each of the MDI and the monoamine are as shown in table 1.

The solution in which the monoamine was dissolved was added to the solution in which the MDI was dissolved while the solution in which the MDI was dissolved was being stirred. The stirring continued for 30 minutes at 100 to 120° C. for reaction to form a diurea compound in the base oil.

An organic-acid metal salt and an antioxidant were added to the base oil at a mixing ratio shown in table 1. The base oil was stirred at 100 to 120° C. for 10 minutes. Thereafter the base oil was cooled and homogenized by a three-roll to obtain grease.

Tests of measuring sound and the amount of wear caused by energization were conducted to examine the performance of the obtained grease. The method carried out in the tests and the condition set in the tests are shown below. Table 1 shows the results.

### Measurement of Sound

Rolling ball bearings (size of bearing: Φ8×Φ22×7 (mm)) in which 0.1 g of grease shown in table 1 was enclosed were prepared. The bearings were operated at 1800 rpm for 30 seconds with an axial load of 7.8N applied thereto to measure a vibration value G (RMS value). The vibration value was evaluated in three stages as shown below.

⊚: vibration value is less than 25 mG
◯: vibration value is less than 50 mG
X: vibration value is not less than 50 mG

### Test of Wear Caused by Energization

1 g of the grease obtained in each of examples and comparison examples was enclosed in each rolling bearing (51106). In a state in which electric current of 2A was applied between the inner ring and the outer ring at a room temperature with an axial load of 1450N applied to each rolling bearing, the rolling bearings were rotated sat 2600 rpm. In 24 hours later, the electrolytic corrosion-caused wear amount of the inner ring and the outer ring was measured as the weight decrease amount thereof. The wear amount was evaluated in three stages as shown below.

⊚: Wear amount is less than 1 mg
◯: Wear amount is less than 2 mg
X: Wear amount is not less than 2 mg

TABLE 1

| | Example | | | | | | Comparison example | | |
|---|---|---|---|---|---|---|---|---|---|
| | 1-1 | 1-2 | 1-3 | 1-4 | 1-5 | 1-6 | 1-1 | 1-2 | 1-3 |
| Components of grease and mixing amount | | | | | | | | | |
| (part by weight) | | | | | | | | | |
| Base grease | | | | | | | | | |
| Base oil | | | | | | | | | |
| Ester oil 1¹⁾ | 62 | 62 | — | — | — | — | 62 | — | — |
| Ester oil 2²⁾ | — | — | 25 | 25 | 25 | — | — | 25 | — |
| Synthetic hydrocarbon oil 1³⁾ | 25 | 25 | — | — | — | 85 | 25 | — | 85 |
| Synthetic hydrocarbon oil 2⁴⁾ | — | — | 62 | 62 | 62 | — | — | 62 | — |
| Thickener | | | | | | | | | |
| Amine: octylamine | 6.6 | 6.6 | 6.6 | 6.6 | 6.6 | 4.1 | 6.6 | 6.6 | 4.1 |
| Amine: cyclohexylamine | — | — | — | — | — | 3.1 | — | — | 3.1 |
| Diisocyanate: MDI⁵⁾ | 6.4 | 6.4 | 6.4 | 6.4 | 6.4 | 7.8 | 6.4 | 6.4 | 7.8 |
| (Total of mixing amount of base grease) | (100) | (100) | (100) | (100) | (100) | (100) | (100) | (100) | (100) |
| Additive | | | | | | | | | |
| Antioxidant⁶⁾ | 2 | 2 | 2 | 2 | 2 | 2 | 2 | 2 | 2 |
| Aluminum stearate⁷⁾ | 2 | — | 2 | — | — | 2 | — | — | — |
| Zinc stearate⁸⁾ | — | 2 | — | 2 | — | — | — | — | — |
| Calcium stearate⁹⁾ | — | — | — | — | 2 | — | — | — | — |
| Viscosity (40° C., mm²/sec) of base oil | 60 | 60 | 40 | 40 | 40 | 46 | 60 | 40 | 46 |
| Worked penetration (JIS K 2220) | 250 | 260 | 250 | 250 | 250 | 240 | 250 | 250 | 240 |
| Measurement of sound | ◯ | ◯ | ⊚ | ⊚ | ⊚ | ◯ | ◯ | ⊚ | ◯ |
| Test of wear caused by energization | ⊚ | ◯ | ⊚ | ◯ | ◯ | ⊚ | X | X | X |

¹⁾Dipentaerythritol ester oil, HATOCOL H2362, kinematic viscosity at 40° C.: 72 mm²/sec
²⁾Polymer ester oil, Ketjenlube 115 produced by Akzo Nobel, kinematic viscosity at 40° C.: 112 mm²/sec
³⁾Synfluid 801 produced by Nippon Steel Chemical Co., Ltd., kinematic viscosity at 40° C.: 46 mm²/sec
⁴⁾Synfluid 601 produced by Nippon Steel Chemical Co., Ltd., kinematic viscosity at 40° C.: 30 mm²/sec
⁵⁾Millionate MT produced by Nippon Polyurethane Industry Co., Ltd
⁶⁾Alkylated diphenylamine
^{7) through 9)}Reagent

As shown in table 1, the grease of each example was capable of effectively preventing electrolytic corrosion from being generated on the rolling surface of the rolling bearing.

### Examples 2-1 through 2-6 and Comparison Examples 2-1 through 2-3

The 4,4′-diphenylmethane diisocyanate (Millionate MT produced by Nippon Polyurethane Industry Co., Ltd., hereinafter referred to as MDI) was dissolved in one half of a base oil shown in table 2 at a ratio shown in table 2. The monoamine was dissolved in the remaining half of the base oil at an equivalent weight two times larger than that of the MDI. The mixing ratio and the kind of each of the MDI and the monoamine are as shown in table 2.

The solution in which the monoamine was dissolved was added to the solution in which the MDI was dissolved while the solution in which the MDI was dissolved was being stirred. The stirring continued for 30 minutes at 100 to 120° C. for reaction to form the diurea compound in the base oil.

Phosphoric acid ester and the antioxidant were added to the base oil at a mixing ratio shown in table 2. The base oil was stirred at 100 to 120° C. for 10 minutes. Thereafter the base oil was cooled and homogenized by a three-roll to obtain grease.

Tests of measuring sound and the amount of wear caused by energization were conducted to examine the performance of the obtained grease in a method and a condition similar to those of the above-described example 1-1. Table 2 shows the results.

TABLE 2

| | Example | | | | | | Comparison example | | |
|---|---|---|---|---|---|---|---|---|---|
| | 2-1 | 2-2 | 2-3 | 2-4 | 2-5 | 2-6 | 2-1 | 2-2 | 2-3 |
| Components of grease and mixing amount | | | | | | | | | |
| (part by weight) | | | | | | | | | |
| Base grease | | | | | | | | | |
| Base oil | | | | | | | | | |
| Ester oil 1¹⁾ | 62 | 62 | — | — | — | — | 62 | — | — |
| Ester oil 2²⁾ | — | — | 25 | 25 | 25 | — | — | 25 | — |
| Synthetic hydrocarbon oil 1³⁾ | 25 | 25 | — | — | — | 85 | 25 | — | 85 |
| Synthetic hydrocarbon oil 2⁴⁾ | — | — | 62 | 62 | 62 | — | — | 62 | — |
| Thickener | | | | | | | | | |
| Amine: octylamine | 6.6 | 6.6 | 6.6 | 6.6 | 6.6 | 4.1 | 6.6 | 6.6 | 4.1 |
| Amine: cyclohexylamine | — | — | — | — | — | 3.1 | — | — | 3.1 |
| Diisocyanate: MDI⁵⁾ | 6.4 | 6.4 | 6.4 | 6.4 | 6.4 | 7.8 | 6.4 | 6.4 | 7.8 |
| (Total of mixing amount of base grease) | (100) | (100) | (100) | (100) | (100) | (100) | (100) | (100) | (100) |
| Additive | | | | | | | | | |
| Antioxidant⁶⁾ | 2 | 2 | 2 | 2 | 2 | 2 | 2 | 2 | 2 |
| Tricresyl phosphate⁷⁾ | 2 | — | 2 | — | — | 2 | — | — | — |
| Trioctyl phosphate⁸⁾ | — | 2 | — | 2 | — | — | — | — | — |
| Triphenyl phosphate⁹⁾ | — | — | — | — | 2 | — | — | — | — |
| Viscosity (40° C., mm²/sec) of base oil | 60 | 60 | 40 | 40 | 40 | 46 | 60 | 40 | 46 |
| Worked penetration (JIS K 2220) | 250 | 260 | 250 | 250 | 250 | 240 | 250 | 250 | 240 |
| Measurement of sound | ◯ | ◯ | ⊚ | ⊚ | ⊚ | ◯ | ◯ | ⊚ | ◯ |
| Test of wear caused by energization | ◯ | ◯ | ⊚ | ◯ | ◯ | ⊚ | X | X | X |

¹⁾Dipentaerythritol ester oil, HATOCOL H2362, kinematic viscosity at 40° C.: 72 mm²/sec
²⁾Polymer ester oil, Ketjenlube 115 produced by Akzo Nobel, kinematic viscosity at 40° C.: 112 mm²/sec
³⁾Synfluid 801 produced by Nippon Steel Chemical Co., Ltd., kinematic viscosity at 40° C.: 46 mm²/sec
⁴⁾Synfluid 601 produced by Nippon Steel Chemical Co., Ltd., kinematic viscosity at 40° C.: 30 mm²/sec
⁵⁾Millionate MT produced by Nippon Polyurethane Industry Co., Ltd
⁶⁾Alkylated diphenylamine
^{7) through 9)}Reagent

As shown in table 2, the grease of each example was capable of effectively preventing electrolytic corrosion from being generated on the rolling surface of the rolling bearing.

### Examples 3-1 through 3-5 and Comparison Examples 3-1 through 3-3

The 4,4′-diphenylmethane diisocyanate (Millionate MT produced by Nippon Polyurethane Industry Co., Ltd., hereinafter referred to as MDI) was dissolved in one half of a base oil shown in table 3 at a ratio shown in table 3. The monoamine was dissolved in the remaining half of the base oil at an equivalent weight two times larger than that of the MDI. The mixing ratio and the kind of each of the MDI and the monoamine are as shown in table 3.

The solution in which the monoamine was dissolved was added to the solution in which the MDI was dissolved while the solution in which the MDI was dissolved was being stirred. The stirring continued for 30 minutes at 100 to 120° C. for reaction to form the diurea compound in the base oil.

An epoxy compound and the antioxidant were added to the base oil at a mixing ratio shown in table 3. The base oil was stirred at 100 to 120° C. for 10 minutes. Thereafter the base oil was cooled and homogenized by a three-roll to obtain grease.

Tests of measuring sound and the amount of wear caused by energization were conducted to examine the performance of the obtained grease. The method carried out in the tests and the condition set in the tests are shown below. Table 3 shows the results.

### Measurement of Sound

Deep groove ball bearings (size of bearing: Φ8×Φ22×7 (mm)) in which 0.1 g of grease shown in table 3 was enclosed were prepared. The bearings were operated at 1800 rpm for 30 seconds with an axial load of 7.8N applied thereto to measure a vibration value G (RMS value). The vibration value was evaluated in three stages as shown below.

⊚: vibration value is less than 25 mG
◯: vibration value is less than 50 mG
X: vibration value is not less than 50 mG

### Test of Wear Caused by Energization

0.5 g of the grease obtained in each of examples and comparison examples was enclosed in each rolling bearing (51106). In a state in which electric current of 2A was applied between the inner ring and the outer ring at a room temperature with an axial load of 1450N applied to each rolling bearing, the rolling bearings were rotated at 2600 rpm. In 24 hours later, the electrolytic corrosion-caused wear amount of the inner ring and the outer ring was measured as the weight decrease amount thereof. The wear amount was evaluated in three stages as shown below.

⊚: Wear amount is less than 1 mg
◯: Wear amount is less than 2 mg
X: Wear amount is not less than 2 mg

TABLE 3

| | Example | | | | | Comparison example | | |
|---|---|---|---|---|---|---|---|---|
| | 3-1 | 3-2 | 3-3 | 3-4 | 3-5 | 3-1 | 3-2 | 3-3 |
| Components of grease and mixing amount | | | | | | | | |
| (part by weight) | | | | | | | | |
| Base grease | | | | | | | | |
| Base oil | | | | | | | | |
| Ester oil 1¹⁾ | 62 | 62 | — | — | — | 62 | — | — |
| Ester oil 2²⁾ | — | — | 25 | 25 | — | — | 25 | — |
| Synthetic hydrocarbon oil 1³⁾ | 25 | 25 | — | — | 85 | 25 | — | 85 |
| Synthetic hydrocarbon oil 2⁴⁾ | — | — | 62 | 62 | — | — | 62 | — |
| Thickener | | | | | | | | |
| Amine: octylamine | 6.6 | 6.6 | 6.6 | 6.6 | 4.1 | 6.6 | 6.6 | 4.1 |
| Amine: cyclohexylamine | — | — | — | — | 3.1 | — | — | 3.1 |
| Diisocyanate: MDI⁵⁾ | 6.4 | 6.4 | 6.4 | 6.4 | 7.8 | 6.4 | 6.4 | 7.8 |
| (Total of mixing amount of base grease) | (100) | (100) | (100) | (100) | (100) | (100) | (100) | (100) |
| Additive | | | | | | | | |
| Antioxidant⁶⁾ | 2 | 2 | 2 | 2 | 2 | 2 | 2 | 2 |
| Epoxy compound⁷⁾ | 2 | — | 2 | — | 2 | — | — | — |
| Epoxy compound⁸⁾ | — | 2 | — | 2 | — | — | — | — |
| Viscosity (40° C., mm²/sec) of base oil | 60 | 60 | 40 | 40 | 46 | 60 | 40 | 46 |
| Worked penetration (JIS K 2220) | 250 | 260 | 250 | 250 | 240 | 250 | 250 | 240 |
| Measurement of sound | ◯ | ◯ | ⊚ | ⊚ | ◯ | ◯ | ⊚ | ◯ |
| Test of wear caused by energization | ⊚ | ⊚ | ⊚ | ⊚ | ⊚ | X | X | X |

¹⁾Dipentaerythritol ester oil, HATOCOL H2362, kinematic viscosity at 40° C.: 72 mm²/sec
²⁾Polymer ester oil, Ketjenlube 115 produced by Akzo Nobel, kinematic viscosity at 40° C.: 112 mm²/sec
³⁾Synfluid 801 produced by Nippon Steel Chemical Co., Ltd., kinematic viscosity at 40° C.: 46 mm²/sec
⁴⁾Synfluid 601 produced by Nippon Steel Chemical Co., Ltd., kinematic viscosity at 40° C.: 30 mm²/sec
⁵⁾Millionate MT produced by Nippon Polyurethane Industry Co., Ltd.
⁶⁾Alkylated diphenylamine
⁷⁾Epicoat 828 produced by Japan Epoxy Resins Co., Ltd.
⁸⁾Epicoat 807 produced by Japan Epoxy Resins Co., Ltd.

As shown in table 3, the grease of each example was capable of effectively preventing electrolytic corrosion from being generated on the rolling surface of the rolling bearing.

### INDUSTRIAL APPLICABILITY

Because the grease enclosed in the bearing for the inverter-driving motor contains the base grease consisting of the base oil and the thickener and the additive comprising the organic-acid metal salt, the phosphoric acid compound or the epoxy compound, the grease restrains damage (electrolytic corrosion) from being generated by high-frequency electric current which has flowed into the bearing from the inverter circuit. Therefore the bearing can be used for a long time and preferably utilized for a motor driven by inverter control.

1. A grease-enclosed bearing, for an inverter-driving motor, which is used as a bearing supporting a rotor of said inverter-driving motor driven by in inverter control, wherein said grease-enclosed bearing comprises an inner ring; an outer ring; a plurality of rolling elements disposed between said inner ring and said outer ring; a sealing member provided at openings disposed at both axial ends of said inner ring and said outer ring; and a grease enclosed on peripheries of said rolling elements,
said inner ring, said outer ring, and said rolling elements are made of an iron-based alloy respectively;
said grease contains a base grease consisting of a base oil and a thickener and an additive containing at least an electrolytic corrosion retarder that restrains generation of electrolytic corrosion;
said electrolytic corrosion retarder is an organic-acid metal salt, a phosphoric acid compound or an epoxy compound; and
a mixing ratio of said electrolytic corrosion retarder for 100 parts by weight of said base grease is set to 0.05 to 10 parts by weight.

2. A grease-enclosed bearing for an inverter-driving motor according to claim 1, wherein said organic-acid metal salt is at least one fatty acid metal salt selected from among fatty acid aluminum, fatty acid zinc, fatty acid calcium, and fatty acid magnesium.

3. A grease-enclosed bearing for an inverter-driving motor according to claim 2, wherein fatty acids composing said fatty acid metal salt are aliphatic organic acids having not less than eight carbon atoms.

4. A grease-enclosed bearing for an inverter-driving motor according to claim 1, wherein said phosphoric acid compound is at least one phosphoric acid ester selected from among tricresyl phosphate, trioctyl phosphate, and triphenyl phosphate.

5. A grease-enclosed bearing for an inverter-driving motor according to claim 1, wherein said epoxy compound is at least one epoxy compound selected from among a bisphenol A type and a bisphenol F type.

6. A grease-enclosed bearing for an inverter-driving motor according to claim 1, wherein said thickener is an urea thickener or a lithium soap-based thickener.

7. A grease-enclosed bearing for an inverter-driving motor according to claim 1, wherein said base oil is at least one oil selected from among ester oil and poly-α-olefin oil.
